(19) United States
(12) Patent Application Publication
(10) Pub. No.: US 2006/0015934 A1
(43) Pub. Date: Jan. 19, 2006

(54) Method and apparatus for automatic risk assessment of a firewall configuration

(75) Inventor: Avishai Wool, Petah Tikva (IL)

Correspondence Address: Algorithmic Security Inc, P.O. Box 100, Kiryat Ono, 55100, IL

(73) Assignee: Algorithmic Security Inc, Kiryat Ono (IL)

(21) Appl. No.: 11/175,781

(22) Filed: Jul. 7, 2005

Related U.S. Application Data
(60) Provisional application No. 60/587,938, filed on Jul. 15, 2004.

(51) Int. Cl. G06F 15/16

(52) U.S. Cl. 726/11

(57) ABSTRACT

Generally, a method and apparatus are disclosed for Automatic Risk Assessment of a Firewall Configuration. The disclosed invention facilitates the automatic generation of a risk assessment of a given firewall configuration. The prior work of [Mayer et al; 2000, Mayer et al; 2005] and [Wool; 2001] teaches how to analyze Firewall Configurations and produce HTML-based Firewall Analyzer Reports. However, the said Reports produced by the methods of [Mayer et al; 2000, Mayer et al; 2005] are voluminous, and do not identify or rate the risks present within the Firewall Configuration. In the current state of the art, a Firewall administrator or auditor needs to navigate through the Firewall Analyzer Report, and use his or her expertise to identify any Configuration mistakes or badly written rules. The current invention automates this manual process. The method is to let a software module, (the “ADVISOR” module) go over the report, before the human user does, and flag the Configuration errors. Each found mis-configuration is called a risk item. According to a further aspect of the present invention, the ADVISOR module utilizes a Knowledge Base of known risk items. The method may be reduced to practice in the form of a software program that can be executed on a standard personal computer with a standard operating system. A preferred embodiment is an Intel x86—based PC running the RedHat Linux operating system.

### CROSS REFERENCE TO RELATED APPLICATIONS

The application is a continuation of provisional U.S. patent application Ser. No. 60/587,938, filed Jul. 15, 2004.

### FIELD OF THE INVENTION

The present invention relates generally to firewalls, and more particularly, to a method and apparatus for Automatic Risk Assessment of a Firewall Configuration.

### BACKGROUND OF THE INVENTION

Network firewalls provide important safeguards for any network connected to the Internet. Firewalls are not simple applications that can be activated “out of the box.” A firewall must be configured and managed to realize an important security policy for the particular needs of a given company or entity. It has been said that the most important factor affecting the security of a firewall is the firewall configuration

A firewall is a network gateway that filters packets and separates a proprietary corporate network, such as an Intranet, from a public network, such as the Internet. Most of today's firewalls are configured by means of a rule-base or firewall configuration file. The rule-base instructs the firewall which inbound sessions (packets) to permit to pass, and which should be blocked. Similarly, the rule-base specifies which outbound sessions (packets) are permitted. The firewall administrator needs to implement the high-level corporate security policy using this low-level rule-base.

The firewall's configuration interface typically allows the security administrator to define various host-groups (ranges of IP addresses) and service-groups (groups of protocols and corresponding port-numbers at the hosts that form the endpoints). A single rule typically includes a source, a destination, a service-group and an appropriate action. The source and destination are host-groups, and the action is generally either an indication to “pass” or “drop” the packets of the corresponding session

In many firewalls, the rule-base is order sensitive. In other words, the firewall checks if the first rule in the rule-base applies to a new session. If the first rule applies, the packets are either passed or dropped according to the action specified by the first rule. Otherwise, the firewall checks if the second rule applies, and so forth until a rule applies. This scheme makes it difficult to understand what policy a firewall configuration is actually implementing, since the user needs to comprehend the effects of the whole rule-base, including any inter-play between subsequent rules.

Analyzing a firewall configuration is much worse for a larger company, whose rule-base may include thousands of rules, and whose firewall administration team includes many staff members, possibly in different locations.

As apparent from the above-described deficiencies with conventional techniques for administering a firewall, a need exists for analyzing and auditing firewall configurations.

The prior work of [Mayer et al; 2000, Mayer et al; 2005] and [Wool; 2001] teaches how to analyze Firewall Configurations and produce HTML-based Firewall Analyzer Reports. However, the said Reports produced by the methods of [Mayer et al; 2000, Mayer et al; 2005] are voluminous, and do not identify or rate the risks present within the Firewall Configuration. In the current state of the art, a Firewall administrator or auditor needs to navigate through the Firewall Analyzer Report, and use his or her expertise to identify any Configuration mistakes or badly written rules. The current invention shows how to automatically augment the Report with a Risk Assessment.

### BRIEF SUMMARY OF THE INVENTION

Generally, a method and apparatus are disclosed for Automatic Risk Assessment of a Firewall Configuration. The disclosed invention facilitates the automatic generation of a risk assessment of a given firewall configuration.

The prior work of [Mayer et al; 2000, Mayer et al; 2005] and [Wool; 2001] teaches how to analyze Firewall Configurations and produce HTML-based Firewall Analyzer Reports. However, the said Reports produced by the methods of [Mayer et al; 2000, Mayer et al; 2005] are voluminous, and do not identify or rate the risks present within the Firewall Configuration. In the current state of the art, a Firewall administrator or auditor needs to navigate through the Firewall Analyzer Report, and use his or her expertise to identify any Configuration mistakes or badly written rules.

The current invention automates this manual process. The method is to let a software module, (the “ADVISOR” module) go over the report, before the human user does, and flag the Configuration errors (see FIG. 1 : Data flow through the ADVISOR). Each found mis-configuration is called a risk item.

According to a further aspect of the present invention, the ADVISOR module utilizes a Knowledge Base of known risk items.

The method may be reduced to practice in the form of a software program that can be executed on a standard personal computer with a standard operating system. A preferred embodiment is an Intel x86—based PC running the RedHat Linux operating system.

A more complete understanding of the present invention, as well as further features and advantages of the present invention, will be obtained by reference to the following detailed description and drawings.

### BRIEF DESCRIPTION OF THE DRAWINGS

FIG. 1 is a schematic block diagram of the ADVISOR module

FIG. 2 illustrates an excerpt from a rule base;

FIG. 3 illustrates a query, and the resulting query result table

FIG. 4 illustrates an excerpt from a host group table

FIG. 5 illustrates an excerpt from a service group table

### DETAILED DESCRIPTION OF THE INVENTION

Introduction

The Firewall analysis that is described in references [Mayer et al; 2000, Wool; 2001, Mayer et al; 2005], produces a very detailed report about the action a Firewall would take on any type of packet it could ever see. We shall refer to an implementation of the methods of [Mayer et al; 2000, Wool; 2001, Mayer et al; 2005] as the Basic Software. The input for the Basic Software consists of the Firewall Configuration files and the Routing Table file. The Basic Software parses these files, produces an internal model, simulates the behavior of the Firewall (algorithmically, without sending any packets), and produces a Basic Report 200 as output.

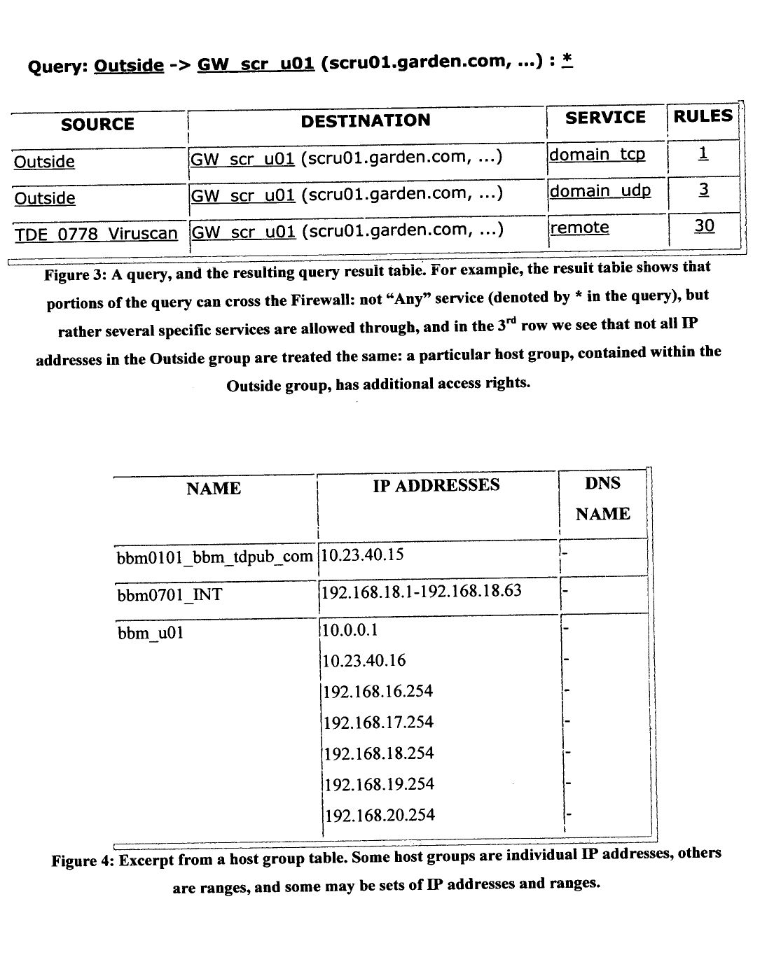

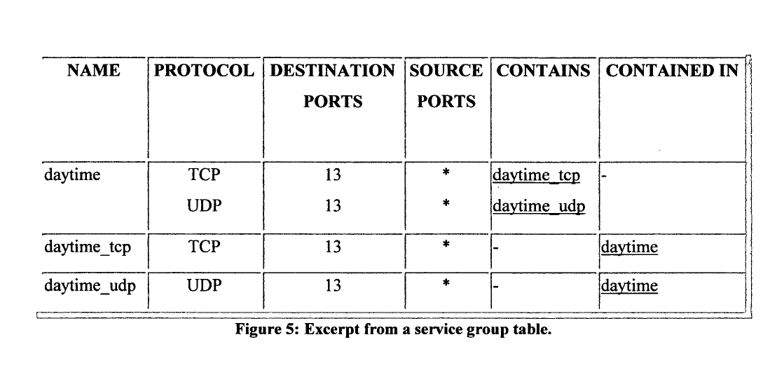

The said Basic Report 200 consists of multiple tables, of several types. These tables are available in several formats: they are produced as blank-separated plain ASCII files, and then translated by the Basic Software into html (hyper-text markup language). The types of tables available in a Basic Report 200 include:
Rule tables: the main columns of a rule table are the source IP address, destination IP address, service (combination of protocol, and source & destination port numbers), and action (e.g., PASS/DROP). Other columns are often shown as well. See FIG. 2 for an example.
Query result tables: a query is of the form “which packets, among those with source IP addresses included in a set Src, destination IP addresses included in a set Dst, and service included in a set Srv, will reach their destination through the Firewall?” The result of a query is a table with columns including (at least): source IP address, destination IP address, service, and rules letting this type of service through. See FIG. 3 for an example.
Host group tables: These describe the IP addresses associated with a named definition, See FIG. 4 for an example.
Service group tables: These describe the protocols and port numbers associated with a named definition, See FIG. 5 for an example.
   Finding Configuration Mistakes
   State of the Art

Many Firewalls are configured incorrectly, and the protection that they offer to the networks behind them is insufficient, as shown by [Wool; 2004]. The Basic Report 200 described above shows the effects of any mis-configuration, for instance, by showing that certain types of traffic are allowed to cross the Firewall. In the current state of the art, a Firewall administrator or auditor would navigate through the Basic Report, and use his or her expertise to identify any Configuration mistakes or badly written rules.

Current Invention

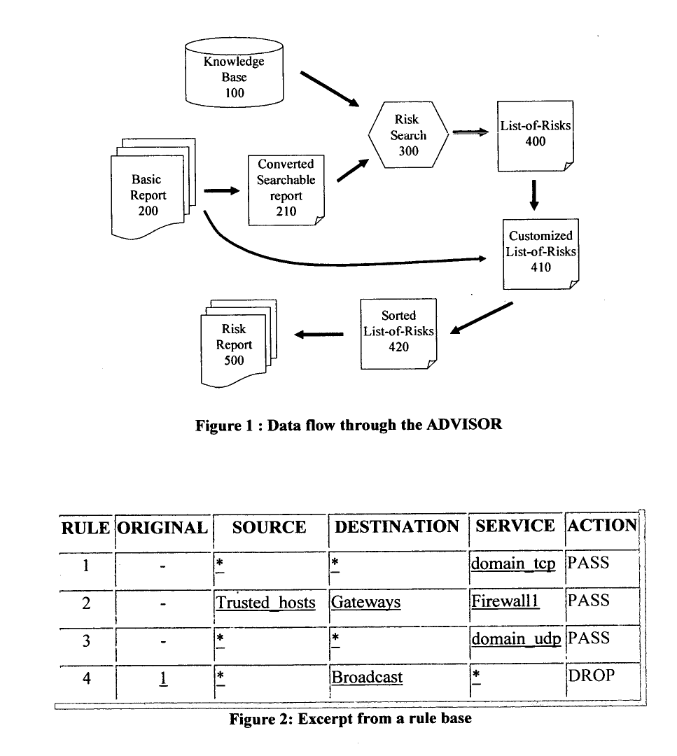

The current invention automates this manual process. The method is to let a software module, (the “ADVISOR” module) go over the report, before the human user does, and flag the Configuration errors (see FIG. 1: Data flow through the ADVISOR). Each found mis-configuration is called a risk item. The method may be reduced to practice in the form of a software program that can be executed on a standard personal computer with a standard operating system. A preferred embodiment is an Intel x86—based PC running the RedHat Linux operating system.

Elements of a Risk Item

For each risk item, the ADVISOR produces all of the following items:
1. A brief description of the risk item (usually a short English sentence)
2. A risk rating (such as High/Medium/Low/Informational/Suspected)
3. An explanation about the risk item, and the reason why it is considered to be a risk
4. Further details of the problem, and its causes, in the form of direct links to other parts of the Basic Report 200
5. A suggestion about possible methods to remedy the problem.
   Additional Components

The ADVISOR module sorts the risk items in decreasing order of risk (higher risks appear first).

Additionally, the ADVISOR produces various statistics and graphic charts about the general state of the analyzed Firewall (such as the number of risk items per risk category, a general rating of the Firewall's Configuration quality, comparison to historic data for the same Firewall or for other Firewalls, comparison to industry averages etc).

The ADVISOR Internals

The ADVISOR module uses a Knowledge Base 100: this is a data store encapsulating the knowledge of a Firewall auditor. The ADVISOR comprises of the following steps:
1. Convert the Basic Report 200 into a Converted Searchable Report 210, in a format that is suitable for searching for Configuration errors.
2. Search the Converted Searchable Report 210 for each of the possible items listed in the Knowledge Base 100, and create a List-of-Risks 400. For each risk item, generate the all the elements of the risk item (in generic form).
3. Customize the found risk items to match the current report to produce a Customized List-of-Risks 410.
4. Sort the Customized List-of-Risks 410 in decreasing risk rating order to produce a Sorted List-of-Risks 420
5. Display the Sorted List-of-Risks 420, and additional statistics and graphics, in the Risk Report 500.

Each of the above steps is described in more detail below.

The Knowledge Base 100

The ADVISOR's Knowledge Base 100 is a data store encapsulating the expertise of a Firewall auditor, combined with an understanding of the structure and organization of the Basic Report. A preferred embodiment of the Knowledge Base 100 is that of an XML (eXtensible Markup Language) document, however other formats (ranging from a flat text file to a relational database) are also possible.

The Knowledge Base 100 consists of multiple items, each detailing a possible risk item. Each possible risk item in the Knowledge Base 100 contains:
1. A search expression. The search expression refers to the schema of the Converted Searchable Report 210. The language used to write the expression is suitable for the Risk Search 300 mechanism described above. A preferred embodiment is an XQL expression (assuming that the Basic Report 200 is converted into XML). Alternative languages could be database query languages such as SQL.

The search expression may be customizable—i.e., it may contain keywords that will be instantiated as part of the search procedure. For instance, a %FWNAME keyword indicates the name of the Firewall.
2. The elements of the risk item. The text in the various elements is written in customizable form: the text contains embedded keywords (such as % FWNAME to indicate the Firewall's name, or % RULE to indicate the number of a found rule).
   Converting the Firewall Analyzer Report to a Searchable Format

In order to search for the possible risk items, the Basic Report 200 (or portions of it) needs to be converted into the Converted Searchable Report 210, in a searchable format. Such a format needs to obey a schema. The schema indicates which columns appear in each table, how the tables relate to each other etc. A preferred embodiment of the Converted Searchable Report 210 is a set of one or more XML documents. Alternative embodiments include database formats (such as MySQL or Oracle). The choice of search expressions in the risk items within the Knowledge Base 100, should be appropriate for the Converted Searchable Report 210 format.

Searching the Report

After the Basic Report (or portions of it) is converted to a Converted Searchable Report 210, the ADVISOR Risk Search 300 performs the following procedure:
1. Loop over all possible risk items in the Knowledge Base 100. For each possible risk item:
   a. Customize the search expression by replacing all the keywords with Firewall-specific information
   b. Search the converted report using the said customized search expression for said possible risk item
   c. If the search is successful, add the possible risk item to the List-of-Risks 400. Note that the elements of the risk item are still generic at this point. Attached to the risk item, the List-of-Risks 400 contains the details of the risk item (such as the rule number, or service name)
2. Repeat steps a,b,c until all possible risk items have been tried.
   Customizing the Risk Items

After the List-of-Risks 400 is created, the ADVISOR performs the following procedure:
1. Loop over all risk items in the List-of-Risk items. For each risk item
   a. Replace the generic keywords with the specific information that is pertinent to the current Basic Report 200 and the current risk item. For instance, the %RULE keyword is replace by the number of the rule that matched the current risk item, and the % FWNAME keyword is replaced by the name of the current Firewall.
   b. Some of the generic keywords indicate hyperlinks to parts of the Basic Report 200 where further details may be found (such as definitions of the found service). These hyperlink keywords are replaced by the appropriate hyperlink information (such as URLs).
   c. Add the customized risk to the Customized List-of-Risks 410.
      Sorting and Presenting the Risk Items

After the Customized List-of-Risks 410 is created, the ADVISOR sorts the risk items in decreasing order of risk (Highest risks appear first) to create the Sorted List-of-Risks 420.

The ADVISOR calculates the various statistics (such as the number of risk items per risk category), and produces this information in tabular, textual, or graphic format. The combination of the Sorted List-of-Risks 420, and the additional statistics and graphics form the Risk Report 500.

The ADVISOR outputs the formatted Risk Report 500 as additional pages that are incorporated into the Basic Report 200. A preferred embodiment is to place the brief description, along with the above-mentioned statistics, into an executive summary, and to place the risk items themselves in a separate risk assessment page.

We claim:

1. A method for parsing a firewall analysis report of a firewall configuration, flagging the risk items, and producing a risk assessment, said method comprising of the following steps:
a. Converting the firewall analysis report into a searchable report format.
b. Searching for each possible risk item in said Converted Report to produce a List-of-Risks.
c. Customizing the List-of-Risks
d. Displaying the Customized List-of-Risks

2. A method as in claim 1 such that the list of possible risk items is maintained in a Knowledge Base.

3. A method as in claim 1 such that said Knowledge Base is maintained in an XML document

4. A method as in claim 1 such that said Knowledge Base is maintained in a relational database

5. A method as in claim 1 such that each risk item in the said Knowledge Base contains
A brief description of the risk item
A risk rating
An explanation about the risk item
Links to further details of the risk
A remedy.

6. A method as in claim 1 such that the Converted Report (1.a) is in XML format

7. A method as in claim 1 such that the Converted Report (1.a) is in a relational database

8. A method as in claim 1 such that the possible risk items are customized before being searched for in said Converted Report (1.b)

9. A method as in claim 1 such that the Customized List-of-Risks (1.d) is sorted in decreasing risk rating order

10. A method as in claim 1 such that the Customized List-of-Risks (1.d) are displayed in HTML format

11. A method as in claim 1 such that the Customized List-of-Risks (1.d) are displayed as a bar chart

12. A system for parsing a firewall analysis report of a firewall configuration, flagging the risk items, and producing a risk assessment, comprising: a memory for storing computer-readable code; and a processor operatively coupled to said memory, said processor configured to execute said computer-readable code, said computer-readable code configuring said processor to: convert the firewall analysis report into a searchable report format; searching for each possible risk item in said Converted Report to produce a List-of-Risks; Customizing the List-of-Risks; and Displaying the Customized List-of-Risks.
